(19) United States
(12) Patent Application Publication
(10) Pub. No.: US 2009/0132508 A1
(43) Pub. Date: May 21, 2009

(54) SYSTEM AND METHOD FOR ASSOCIATING A CATEGORY LABEL OF ONE USER WITH A CATEGORY LABEL DEFINED BY ANOTHER USER

(75) Inventor: Janto Skowronek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/298,924

(22) PCT Filed: Apr. 20, 2007
(86) PCT No.: PCT/IB2007/051465

§ 371 Date: Oct. 29, 2008

(30) Foreign Application Priority Data
May 2, 2006 (EP) 06113346.8

(51) Int. Cl. G06F 7/06; G06F 17/30

(52) U.S. Cl. 707/4; 707/100; 707/E17.044; 707/E17.014

(57) ABSTRACT

A method of processing message from a user of a system (1-4) for storing sets of data representing a first collection (11) of content items (12), each including a recording of at least one perceptible content element, includes obtaining information (13; 19) representative of a first assignment of category labels to content items (12) in the first collection (11), wherein the message includes an indication of a category label used in the first assignment. The method further includes obtaining information (14) representative of a second assignment of category labels to content items (12) including a recording of at least one perceptible content element, and matching with the category label indicated in the message an indication of at least one of the category labels used in the second assignment by determining a measure of similarity between content items (12) assigned the category label indicated in the message in the first assignment and content items (12) assigned category labels in the second assignment.

The invention relates to a method of processing a message from a user of a system for storing sets of data representing a first collection of content items. The invention also relates to a system configured to carry out such a method, and to a computer program.

An example of such a method, system and computer program is known from U.S. Pat. No. 5,918,223. That publication describes a system that performs analysis and comparison of audio data files based upon the content of the data files. The analysis of the audio data produces a set of numeric values (a feature vector) that can be used to classify and rank the similarity between individual audio files typically stored in a multimedia database or on the World Wide Web. The analysis also facilitates the description of user-defined classes of audio files, based on an analysis of a set of audio files that are members of a user-defined class. Thus, the known system provides a means for finding audio data files that sound similar to predefined classes of sounds.

A problem of the known system is that the analysis for classification and ranking is carried out anew with each query based on a user-defined class, returning individual files. This problem can, for example, come to the fore when the known method is applied to the music collection of a second user, stored on the second user's portable media player.

It is an object of the invention to provide a method, system and computer program as defined in the opening paragraphs that provide a more efficient way of using a user's classification of content items in communications relating to content items.

This object is achieved by the method according to the invention, which comprises a step of obtaining information representative of a second assignment of category labels to content items including a recording of at least one perceptible content element, and

matching with the category label indicated in the message an indication of at least one of the category labels used in the second assignment by

determining a measure of similarity between content items assigned the category label indicated in the message in the first assignment and content items assigned category labels in the second assignment.

Because the message includes an indication of a category label used in the first assignment, it is suitable for use in conjunction with a first assignment of category labels made by the user, who may also generate the message. Because an indication of at least one of the category labels used in the second assignment is obtained, the method is suitable for use in translating between a category label used in the first assignment and those used in a second assignment carried out by another user. It is more efficient than retrieval of individual content items in another collection, because the category labels that are obtained by matching allow for faster retrieval of content items assigned that label in the second assignment. Content items can be retrieved by the returned category label, with which recordings thereof have been annotated. Due to the matching of content labels by determining a measure of similarity between content items assigned the category label indicated in the message in the first assignment and content items assigned category labels in the second assignment, the translation is amenable to implementation on a data processing system. Because each content item includes a recording of at least one perceptible content element, the similarity determined by such a processing system is likely to correspond to a categorisation made by a user.

It is observed that US 2003/0037036 discloses a process that generates rules for a classification system. A first level of expert classification is implemented whereby experts classify a set of training songs in a database. Before, after or at the same time as the human classification process, the songs from the database are classified according to digital signal processing (DSP) techniques. The quantitative machine classifications and qualitative human classifications for a given piece of media, such as a song, are then placed into what is referred to as a classification chain. A machine learning classification module marries the classifications made by humans and the classifications made by machines, and in particular, creates a rule when a trend meets certain criteria. The technique maps a pre-defined parameter space to a psycho-acoustic perceptual space defined by musical experts. People are trained to be, or certified as “musical experts” for purposes of uniformly applying classification techniques. Thus, this known method does not involve a second assignment of category labels, nor does it involve determining similarity between content items assigned a category label indicated in a message in the first assignment and content items assigned category labels in the second assignment. For these reasons primarily, a new user must be trained to become a musical expert, i.e. to apply a universal classification correctly.

An embodiment includes determining the measure of similarity by comparing data derived from representations of at least sections of at least one recording of a perceptible content element included in respective content items assigned the category label indicated in the message in the first assignment and data derived from representations of at least sections of at least one recording of a perceptible content element included in respective content items assigned category labels in the second assignment.

An effect is that the first assignment of category labels need not have been made to the same collection of content items as the second assignment of category labels.

In an embodiment, the compared data comprises data derived from parametric representations of at least sections of at least one recording of a perceptible content element, each parametric representation being obtainable by applying at least one pre-determined analysis algorithm to at least the section.

An effect is that the comparison can be carried out more efficiently, and therefore faster.

An embodiment includes obtaining data identifying a first sub-space within a feature space defined by possible ranges of parameters constituting the parametric representation, the data identifying the first sub-space being representative of a portion of the space spanned by the parametric representations of at least sections of at least one recording of a perceptible content element included in the content items assigned the category label indicated in the message in the first assignment, and

determining a distance or degree of overlap of the first sub-space with points or further sub-spaces in the feature space, representative of the parametric representations of at least sections of the recordings of at least one perceptible content item included in content items assigned category labels in the second assignment.

This allows for a relatively efficient and accurate determination of the correspondence between category labels used in the first assignment and those used in the second assignment. A sub-space is based on several content items assigned the same category label. Comparing sub-spaces rather than several individual parametric representations of respective recordings of perceptible content items is relatively efficient.

In an embodiment, the data identifying the first sub-space is obtained through a network link by a system for determining the distance or degree of overlap from the system for storing sets of data representing the first collection of content items.

Such an implementation in a distributed system, for example an Internet-based recommendation system, is characterised by relatively efficient communication between the systems, since the complete recordings of content items need not all be transferred across the network link.

An embodiment, wherein the indication of a category label is included in a body of the message as a character string, includes

returning at least the body of the message with the character string replaced by or linked to a character string encoding the returned indication of at least one category label used in the second assignment.

Such an embodiment is suited relatively well to use in an Internet forum for discussing media items, e.g. movies, songs, etc. The categorisation used by one user to describe the media items is automatically converted into that used by other participants in the forum, either directly, or upon activation of the link.

An embodiment further includes using at least one of the category labels of which an indication is returned to formulate a query for searching a database of sets of data representing a second collection of content items, each including a recording of at least one perceptible content element, at least some of the sets of data being stored in association with category labels corresponding to those assigned in the second assignment.

This is a relatively efficient way of searching a database using a category indication as employed by a first user where another entity has annotated the second collection on the basis of his or her own set of category labels.

According to another aspect of the invention, there is provided a system for processing a message from a user of a system for storing sets of data representing a first collection of content items, each including a recording of at least one perceptible content element, configured to carry out a method according to the invention.

The system may be embodied in a media player, e.g. a portable media player. The invention may also be realised with a server for providing a service of translating the category defined by one user into another category defined by the other user. The server may be configured for communicating with personal devices of different users storing media content items assigned user-defined categories or annotations.

According to another aspect of the invention, there is provided a computer program including a set of instructions capable, when incorporated in a machine-readable medium, of causing a system having information processing capabilities to perform a method according to the invention.

The invention will be explained in further detail with reference to the accompanying drawings, in which:

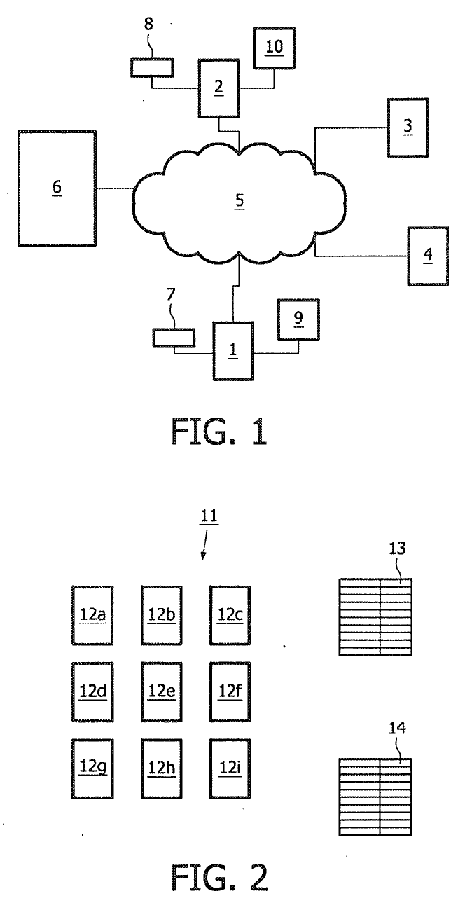

FIG. 1 shows in very schematic fashion parts of a distributed computing environment for implementing various methods of processing a message from a user including an indication of a category label;

FIG. 2 shows in very schematic fashion a collection of files including recordings of perceptible content elements;

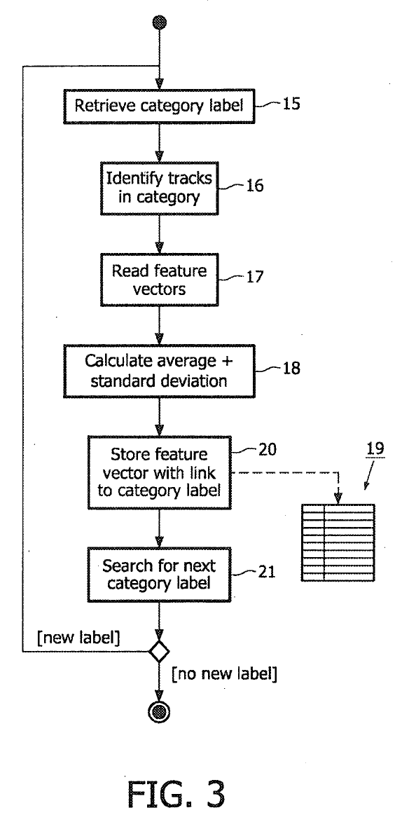

FIG. 3 is a flow chart illustrating the generation of a user profile; and

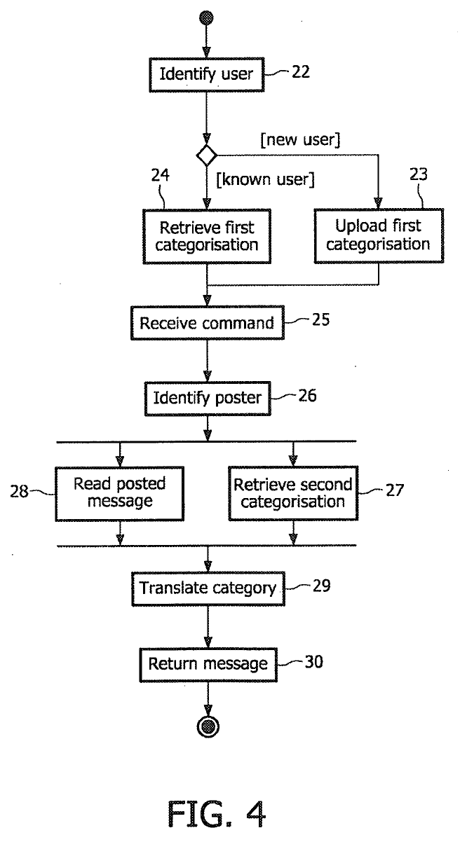

FIG. 4 is a flow chart illustrating a method executed by a server for hosting an Internet forum.

In very schematic fashion, FIG. 1 shows how a first personal computer 1, a second personal computer 2, a first media player 3 and a second media player 4 are connected to a network 5. The network 5 may be a Local Area Network, a Wide Area Network or a Large Area Network, such as the Internet. A server 6 is similarly connected to the network 5. Each of the first and second personal computers 1,2 and first and second media players 3,4 comprises a processor and memory for storing instructions for execution by the processor (not shown in detail). The first and second personal computers 1,2 include respective first and second input devices 7,8 and first and second output devices 9,10. The first and second output devices 9,10 each comprise at least one visual display unit (VDU).

Each of the first and second personal computers 1,2 and first and second media players 3,4 further includes a respective storage device (not shown) for storing media files. In the following, the content items represented by the media files will be assumed to be audio tracks. In other embodiments, the media files will additionally include video fragments synchronised with at least one audio track. In yet other embodiments, the media files are constituted by images or by documents in a particular kind of mark-up language. In each case, the file representing the content item includes a recording of at least one perceptible content element. The recording is suitable for rendering by an appropriate device to allow it to be perceived. The content element can be a visible content element, such as an image or sequence of images, an audible content element, or a combination thereof.

FIG. 2 shows a collection 11 of audio files 12a-12i. Each audio file 12 includes a recording of an audio track, in an encoded and optionally compressed form. In addition, each audio file 12 can include annotation, such as information concerning the audio track, e.g. the name of a performing artist, track title, etc. In one variant (not shown), each audio file 12 includes information representative of one or more category labels. In the variant illustrated in FIG. 2, a first table 13, associated with a first user, and a second table 14, associated with a second user, includes information associating category labels with selected ones of the audio files 12a- 12i. The first table 13 includes information representative of a first assignment of category labels to the audio files 12. The second table 14 constitutes information representative of a second assignment of category labels to the audio files 12.

In one variant, the category labels are selected by the user from a set of pre-defined category labels and assigned by the user to those of the audio files 12a-12i he considers to fall within the labelled category. In another variant, the user determines the category labels. It will be appreciated that in both cases the first table 13 will differ from the second table 14, due to a different appreciation of the sound tracks included in the audio file 12a-12i. It is further noted that one audio file 12 can have been assigned several category labels.

It is noted that a different collection of audio files will be present on each of the first and second personal computers 1,2 and first and second media players 3,4. In other embodiments, there will be only one list like the first and second lists 13,14 on the device. This one list need not be associated with one particular user if the device for rendering the perceptible content element is shared by multiple users.

In operation, each of the first and second personal computers 1,2 and first and second media players performs a method as illustrated in FIG. 3. This method is performed conditionally or at regular intervals, depending on the variant. It operates on one of the first and second lists 13,14, i.e. using one assignment of category labels to audio files 12. Here, it will be assumed that the first list 13 is used.

In a first step 15, a category label is retrieved from the first list 13. Next (step 16), audio files 12 assigned that category label are identified in the collection 11. Then (step 17), a feature vector is retrieved for each of the identified audio files 12.

A feature vector is a parametric representation of at least a section of the audio track included in the audio file 12 concerned. Each parametric representation is obtainable by applying at least one pre-determined analysis algorithm to the section. The feature vector contains a number of elements, each consisting of a parameter value that quantifies a dimension of a multi-dimensional feature space. The multi-dimensional feature space describes perceptually important properties of an audio track. Each value in the feature vector associated with a particular audio track is obtained by applying a pre-determined analysis algorithm to a signal representing at least a section of that particular audio track. In certain embodiments, several signals, each based on a different section of the audio track, are analysed. Different values in the feature vector may in such case relate to different sections.

The use of a computational method based on a pre-determined analysis algorithm ensures that the feature vector is an objective characterisation of perceptual properties of at least a section of the audio track concerned. It is more compact than a representation encoding the entire section of the audio track concerned.

Depending on the implementation, the analysis algorithm may take PCM (Pulse-code Modulation) values, DCT (Discrete Cosine Transform) coefficients, or any other convenient form of encoded audio signal as input. Suitable analysis algorithms for quantifying perceptually important properties of an audio track are known as such. For this reason, they are not described in any great detail herein. One example is described in Klapuri et al., “Analysis of the Meter of Acoustic Musical Signals”, IEEE Trans. Speech and Audio Proc.This article describes a method which analyses the meter of acoustic musical signals at the tactus, tactum and measure levels, which correspond to different time scales. The result can be used, for example, to identify the genre of music (classical, jazz, etc.). Another example of an algorithm that can be used to obtain parameters characterising a section of an audio track is presented in Sheirer, E.D., “Tempo and beat analysis of acoustic musical signals”, J. Acoust. Soc. Am., 103 (1), January 1998. A further possibility is to model an audio track or section of an audio track using Mel Frequency Cepstral Coefficients, as employed also in speech recognition algorithms.

After the step 17 of reading the feature vectors, a set of data identifying a sub-space within the multi-dimensional feature space is determined (step 18). The sub-space is representative of a portion of the multi-dimensional feature space spanned by the feature vectors read in the preceding step 17. In the illustrated embodiment, this step 18 involves calculating the average value and standard deviation for each element in the feature vectors over the set of feature vectors read in in the previous step 17. In an alternative embodiment, the maximum and minimum values is determined.

The data derived in this step 18 is entered into a table 19 in a subsequent step 20. The table 19 links each category label defined in the first list 13 to a set of data identifying a sub-space within the feature space. To complete the table 19, a next step 21 involves searching the first list 13 for a new category label. If one is found, the steps 15-18, 20, 21 are repeated. Otherwise, the routine illustrated in FIG. 3 is terminated.

The table 19 is usable to translate category labels in the first list 13 to the category labels in the second list 14. To carry out such a translation, a second version of the table 19, based on the second list 14, is obtained. A category label present in the table 19 is received as input in a message (the “search category”). The data defining the sub-space associated with that category label is read from the table 19. Then, the degree of overlap with each sub-space defined in the table based on the second list 14 is determined, to identify category labels in the second list 14 that correspond to the search category. In one alternative, the category label associated with the sub-space with the largest degree of overlap is returned. In another embodiment, all category labels in the second list 14 associated with a respective sub-space having more than a pre-determined minimum degree of overlap are returned. In yet another embodiment, a distance measure is employed, so that even a category label in the second list 14 associated with a sub-space having no overlap with the sub-space associated with the search category could be returned as output. Combinations of these alternatives are also conceivable, wherein one or more comparisons are only carried out if another leads no result. For example, if there are no overlaps between sub-spaces, the distance metric could be employed. In an alternative, the type of measure of similarity is dependent on user input. For example, the distance metric might be used instead of the determination of the degree of overlap, in case a user would like to broaden his taste for a particular category of music.

In an alternative, rough translation, one feature vector is read for each category label in the second list 14. Then, a determination is made of which feature vectors lie within the sub-space corresponding to the search category label and/or which lie closest to the sub-space according to a pre-defined distance metric.

Two applications involving a translation between category labels using data defining sub-spaces in feature space will be described. In a first application, the table 19 generated on the basis of the first list 13 is used to search for audio files in a collection stored on another device. In a second application, such a table 19, linked to a particular user, is used to translate text strings in postings to an Internet forum, or bulletin board.

For the first application, for example, the second media player 4 may carry out the determination of the distance to, or degree of overlap with, the sub-space associated with the search category. To this end, data representative of the table 19 are transferred from the first media player 3 to the second media player 4. A message including an indication of the search category label is also input to the second media player 4, either directly via controls on the second media player 4, or as a message from the first media player 3 to the second media player 4. The second media player 4 returns one or more category labels as assigned to audio files 12 stored in the second media player 4. The category labels returned can be used, for example to formulate a query for searching a database of audio files, each stored in associated with category labels corresponding to those assigned by the user of the second media player 4. Thus, the translation of category labels can be used to carry out a relatively fast search for audio files 12 to be transferred from the second media player 4 to the first media player 3.

The second application is illustrated in FIG. 4. In this case, the server 6 carries out the translation between category labels used by different users. The server 6 is configured to execute software for providing an Internet forum facility. The Internet forum relates to audio files in this example. The same principles are applied in case the Internet forum relates to another type of content item, e.g. video or image files.

A table such as the table 19 illustrated in FIG. 3 is associated with each registered user of the facility. It contains the category labels employed by the associated user. With each category label is stored a set of data defining a sub-space in perceptual feature space. This set of data is determined by applying the method illustrated in FIG. 3 to the collection of audio files to which the user has assigned the category labels.

When a user logs on to the Internet forum, he or she is identified (step 22), for example by means of a user name. If the user is new, the table 19 associated with the user is uploaded to the server (step 23). If the user is known, the table 19 is retrieved (step 24) from a storage device associated with the server 6.

The server 6 receives a command from a first user to view a particular message posted by another user (step 25). The identity of the other user is determined (step 26) to retrieve the table 19 associated with the other user (step 27). The posted message is also read (step 28). It includes a message body including encoded character strings. The character strings corresponding to category labels present in the table 19 associated with the other user are determined and translated to category labels in the table 19 associated with the first user (step 29). This step 29 involves determining a measure of similarity using one of the methods outlined above. Then, the character strings indicating a category label as used by the poster of the message are replaced by or linked to character strings indicating the category label or labels used by the first user. The translated message or message provided with links is then transferred as a message to the first user for display on one of the first and second output devices 9,10.

In case links are provided, metadata are appended to the character strings encoding the category labels used by the poster of the message. The metadata turn the character strings into active elements, such that the character string indicating the category label or labels used by the first user is displayed when the first user provides a command selecting the active element. The command may be provided by placing a cursor over the active element, as is known in the art.

The applications described above have in common that the category labels assigned by one user are translated to those assigned by another user, using the objectively derivable feature vector space. Thus, communication between the users is facilitated, and unnecessary communication due to misunderstandings is prevented.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

For example, where the first assignment of category labels and the second assignment of category labels have been carried out on the same or substantially the same collection of content items. A measure of similarity between content items assigned the category label in the message in the first assignment and content items assigned category labels in the second assignments may be the identity of content items and/or annotations of the content items, such as title, performing artist, etc. In a distributed system, the data associating assigned category labels with content items may be stored and the content items themselves may be stored on different devices. In embodiments, data may be transferred between the first and second media players 3,4 over a personal area network link, for example an optical or wireless data link.

1. Method of processing a message from a user of a system (1-4) for storing sets of data representing a first collection (11) of content items (12), each including a recording of at least one perceptible content element, including
obtaining information (13; 19) representative of a first assignment of category labels to content items (12) in the first collection (11),
wherein the message includes an indication of a category label used in the first assignment,
obtaining information (14) representative of a second assignment of category labels to content items (12) including a recording of at least one perceptible content element, and
matching with the category label indicated in the message an indication of at least one of the category labels used in the second assignment by
determining a measure of similarity between content items (12) assigned the category label indicated in the message in the first assignment and content items (12) assigned category labels in the second assignment.

2. Method according to claim 1, including determining the measure of similarity by comparing data derived from representations of at least sections of at least one recording of a perceptible content element included in respective content items (12) assigned the category label indicated in the message in the first assignment and data derived from representations of at least sections of at least one recording of a perceptible content element included in respective content items assigned category labels in the second assignment.

3. Method according to claim 2, wherein the compared data comprises data derived from parametric representations of at least sections of at least one recording of a perceptible content element, each parametric representation being obtainable by applying at least one pre-determined analysis algorithm to at least the section.

4. Method according to claim 3, including obtaining data identifying a first sub-space within a feature space defined by possible ranges of parameters constituting the parametric representation, the data identifying the first sub-space being representative of a portion of the space spanned by the parametric representations of at least sections of at least one recording of a perceptible content element included in the content items assigned the category label indicated in the message in the first assignment, and
determining a distance or degree of overlap of the first sub-space with points or further sub-spaces in the feature space, representative of the parametric representations of at least sections of the recordings of at least one perceptible content item included in content items assigned category labels in the second assignment.

5. Method according to claim 4, wherein the data identifying the first sub-space is obtained through a network link (5) by a system (1-4,6) for determining the distance or degree of overlap from the system (1-4) for storing sets of data representing the first collection (11) of content items (12).

6. Method according to claim 1, wherein the indication of a category label is included in a body of the message as a character string, including
returning at least the body of the message with the character string replaced by or linked to a character string encoding the returned indication of at least one category label used in the second assignment.

7. Method according to claim 1, further including using at least one of the category labels of which an indication is returned to formulate a query for searching a database of sets of data representing a second collection of content items (12), each including a recording of at least one perceptible content element, at least some of the sets of data being stored in association with category labels corresponding to those assigned in the second assignment.

8. System for processing a message from a user of a system (1-4) for storing sets of data representing a first collection (11) of content items (12), each including a recording of at least one perceptible content element, configured to carry out a method according to claim 1.

9. Computer program including a set of instructions capable, when incorporated in a machine-readable medium, of causing a system having information processing capabilities to perform a method according to claim 1.
